(19) United States
(12) Patent Application Publication
(10) Pub. No.: US 2002/0196633 A1
(43) Pub. Date: Dec. 26, 2002

(54) SELF-SUPPORTED LAMP STRUCTURE

(76) Inventor: Ming-Hsien Huang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/887,355

(22) Filed: Jun. 25, 2001

(51) Int. Cl. F21V 21/00; H01R 33/00

(52) U.S. Cl. 362/431; 362/226; 362/391

(57) ABSTRACT

This invention relates to a multi-used patterned lamp, which includes a connector with an inner cap. A tube with a patterned lamp is capable of being connected with the connector easily. The connector can connect with a rod, which is inserted into the ground to obtain a standing decorative patterned lamp. The connector can also be hanged by a rope or the electrical wire to become a hanging decorative patterned lamp.

### BACKGROUND OF THE INVENTION

It is known that a patterned lamp is used to display a special decorative effect by various designs. There is a kind of patterned lamp, which uses a rod to connect with the lamp at top end and to insert its lower end into the ground. There is another kind of patterned lamp, which can be hanged by the electrical wire of the bulb assembly to obtain a different decorative style. The known patterned lamp has its own structure for the single display and is not changeable.

Accordingly, the primary object of the invention is to provide a multi-used patterned lamp, which can be displayed in a hanging state by the wire as well as a standing state by the rod. Now the features and advantages of the invention will be described in detail with reference to the accompanying drawings.

### BRIEF DESCRIPTION OF THE INVENTION

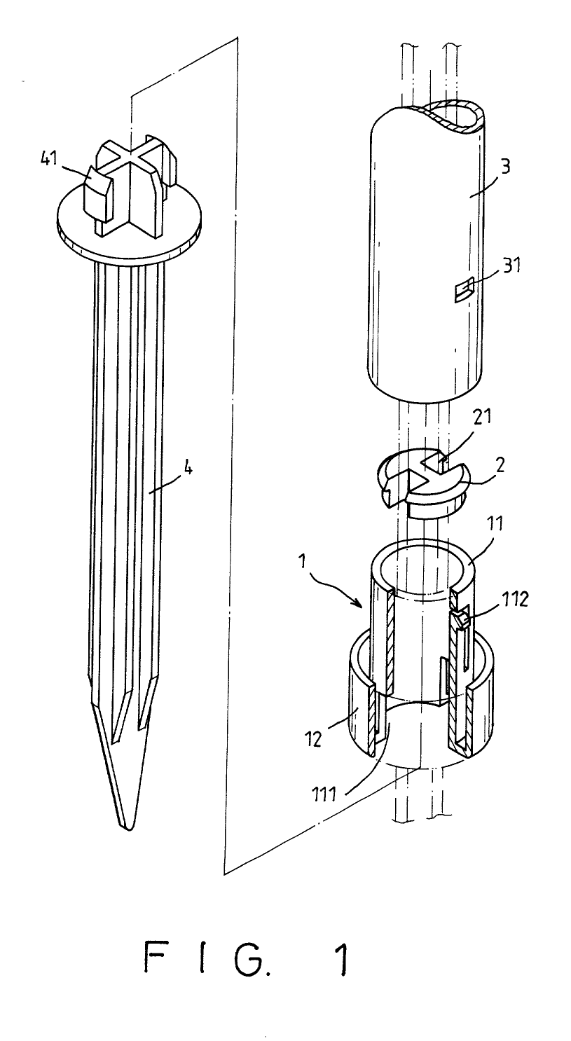

FIG. 1 is an exploded perspective view showing a patterned lamp used in a standing state according to the present invention.

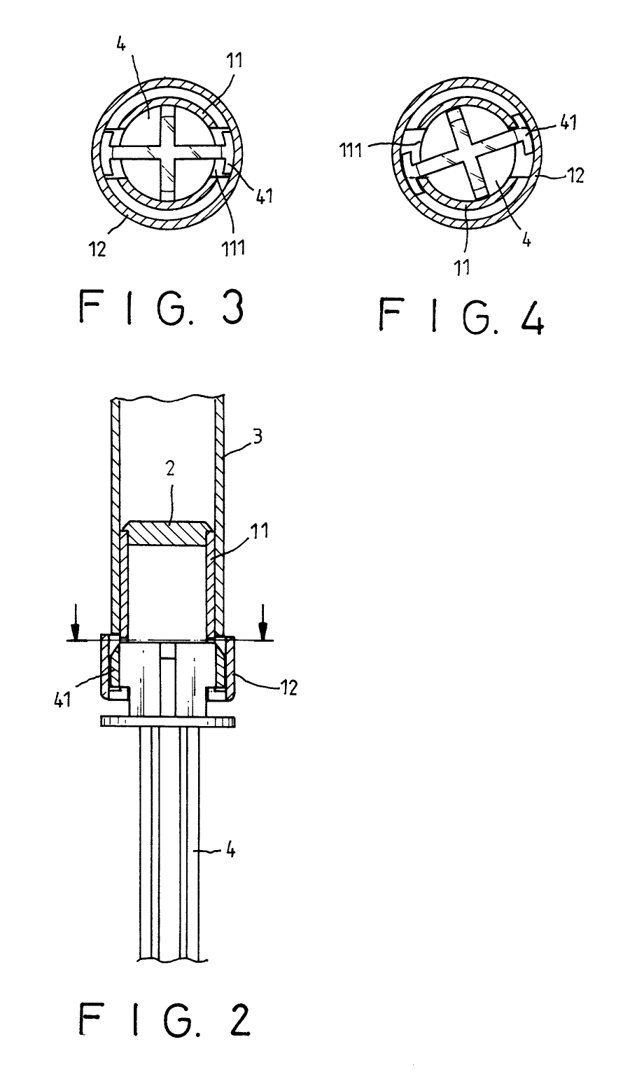

FIG. 2 is an assembled cross-sectional plan view of FIG. 1 according to the present invention.

FIG. 3 is a cross-sectional plan view alone line 3-3 of FIG. 2.

FIG. 4 is a plan view of FIG. 3 after rotating an angle for engagement.

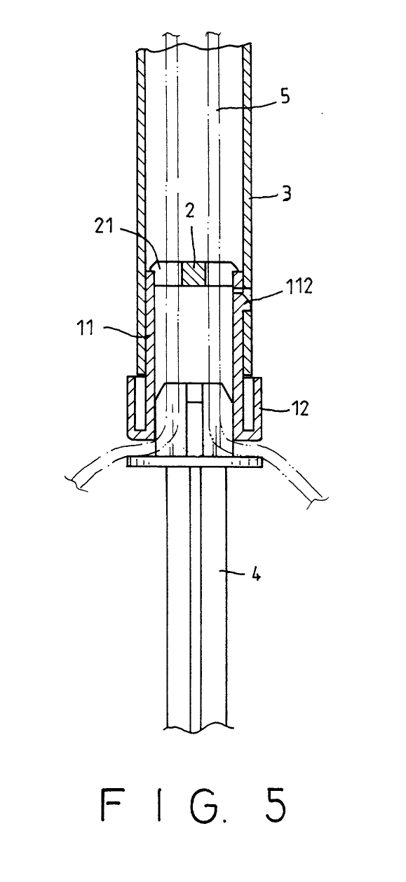

FIG. 5 is a side plan view of FIG. 2 when connecting with the electrical wire.

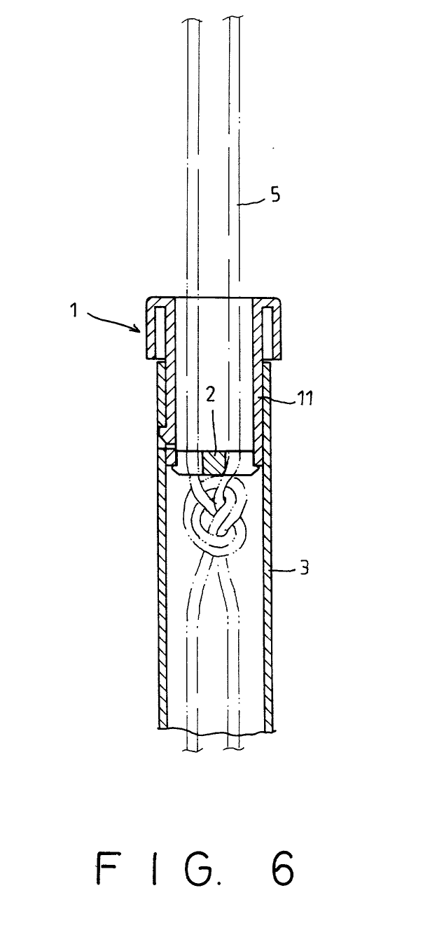

FIG. 6 is a cross-sectional plan view showing a patterned lamp used in a hanging state according to the present invention.

### DETAILED DESCRIPTION OF THE INVENTION

Please refer to FIGS. 1 to 2, it shows a standing patterned lamp according to the present invention, which includes a connector (1) having an inner sleeve (11) and an end folded outer sleeve (12). Two engaging groove (111) are formed on opposite side of the inner sleeve (11) related inside the outer sleeve (12). A longitude elastic hooking slice (112) is provided at a side of the inner sleeve (11). A cap (2) having two separated openings (21) is placed at the top end of the connector (1). A tube (3) having a side groove (31) can connect with the connector (1), and when the hooking slice (112) engages with the side groove (31), the connector (1) and the tube (3) are combined together firmly. The patterned lamp is connected at the other end of the tube (3).

A rod (4) has two arched portions (41) at the top end to insert into the connector (1) to match with the engaging groove (111), as shown in FIGS. 3 and 4, and then the rod (4) can be rotated a small angle to obtain a secure connection between the rod (4) and the connector (1) with the tube (3) and the patterned lamp as a completed body. While the rod (4) is inserted into the ground at lower end and the electrical wires (5) are extended downward from separated opening (21) to electrical source or another lamp, as in FIG. 5, the present invention becomes a standing patterned lamp.

Referring to FIG. 6, it shows a hanging patterned lamp according to this invention. In hanging display, the connector (1) is turned up side down without the rod (4). A rope or the electrical wire (5) is used to pass through the opening (21) of the cap (2) and is winded. The connector (1) is then hanged, while the tube (3) with another shape of the patterned lamp can be displayed in such hanging state.

Accordingly, the present invention provides a new assembled structure, which can provide a multi-used patterned lamp including standing and hanging for improving the utilized decoration. Evidently it meets the requirements of granting a patent. We hereby file an application for a patent grant.

What is claimed is:

1. A multi-used patterned lamp including a connector having an inner sleeve and an end folded outer sleeve, wherein two engaging groove are formed on opposite side of the inner sleeve related inside the outer sleeve and a longitude elastic hooking slice is provided at a side of the inner sleeve; a cap having two separated openings being placed at the top end of the connector, and a tube having a side groove connecting with the connector at one end and connecting with a patterned lamp at the other end, and when the hooking slice engages with the side groove, the connector and the tube being combined together firmly.

2. The multi-used patterned lamp as claimed in claim 1, wherein a rod having two arched portions at the top end to insert into the connector to match with the engaging groove, and then the rod being rotated a small angle to obtain a secure connection between the rod and the connector with the tube and the patterned lamp to become a standing patterned lamp.

3. The multi-used patterned lamp as claimed in claim 1, wherein the connector being turned up side down without the rod, and a rope or the electrical wire being used to pass through the opening of the cap and being winded; the connector being then hanged, while the tube with another shape of the patterned lamp can be displayed in such hanging state.
